(19) United States
(12) Patent Application Publication
(10) Pub. No.: US 2013/0107146 A1
(43) Pub. Date: May 2, 2013

(54) DISPLAY APPARATUS

(71) Applicants: Taeho KIM, Asan-si (KR); Seongnam LEE, Seoul (KR); Jung-Hun LEE, Seoul (KR); Kihyung KANG, Suwon-si (KR); Seungbeom PARK, Seoul (KR); Duckjong SUH, Seoul (KR)

(72) Inventors: Taeho KIM, Asan-si (KR); Seongnam LEE, Seoul (KR); Jung-Hun LEE, Seoul (KR); Kihyung KANG, Suwon-si (KR); Seungbeom PARK, Seoul (KR); Duckjong SUH, Seoul (KR)

(73) Assignee: SAMSUNG DISPLAY CO., LTD., Yongin-City (KR)

(21) Appl. No.: 13/484,273

(22) Filed: May 30, 2012

(30) Foreign Application Priority Data
Nov. 1, 2011 (KR) 10-2011-0112992

(51) Int. Cl. G02F 1/1335

(52) U.S. Cl. 349/15

(57) ABSTRACT

Provided is a display apparatus including: a light illuminating unit to generate light; a display panel to display an image; and a changing panel disposed between the light illuminating unit and the display panel, to be turned off in a two-dimensional operation mode to provide the light to the display panel and to be turned on in a three-dimensional operation mode to change an optical path of the light. The changing panel includes: a first substrate including a common electrode; a second substrate including a plurality of electrodes facing the common electrode and spaced apart from each other in at least one direction; and a liquid crystal layer interposed between the first substrate and the second substrate.

### CROSS-REFERENCE TO RELATED APPLICATION

This application claims priority from and the benefit of Korean Patent Application No. 10-2011-0112992 filed on Nov. 1, 2011, which is hereby incorporated by reference for all purposes as if fully set forth herein.

### BACKGROUND OF INVENTION

1. Field of Invention

Exemplary embodiments of the present invention relate to a display apparatus. More particularly, exemplary embodiments of the present invention relate to a display apparatus capable of displaying three-dimensional images as well as two-dimensional images.

2. Discussion of Background

Typically, a three-dimensional (3D) image display apparatus provides left-eye images and right-eye images having a binocular disparity to the left eye and right eye of an observer, respectively. In order to use binocular disparities in 3-D displays, a lenticular lens or a parallax barrier is disposed on and/or spaced apart from a two-dimensional image display panel to provide different image information to the left and right eyes of the observer.

The three-dimensional image display apparatus employing a lenticular lens renders left and right images on the focal surface of the lenticular lens having a semi-cylindrical shape arranged in stripes to separate the left and right images according to the directivities of the lens, so that the observer perceives the three-dimensional images without wearing glasses.

The three-dimensional image display apparatus employing a parallax barrier has slits arranged in the form of stripes at regular intervals to transmit or block light, and alternately arranges the left and right images in the front or rear of the slits. Accordingly, when the observer views the images through the slits from a specific view point, the left and right images appear separated and the observer perceives the images as three-dimensional.

The slits in the parallax barrier of a typical three-dimensional image display, however, may cause moiré phenomena, which refer to the creation of dark bands on the display when the display apparatus operates in the two-dimensional mode. It is mainly due to diffraction caused by the slits in the parallax barrier.

Therefore, there is a need for three-dimensional image displays having less of moiré phenomena and an improved image quality.

### SUMMARY OF INVENTION

Exemplary embodiments of the present invention provide a display apparatus for displaying two-dimensional images and three-dimensional images and capable of preventing a moiré phenomenon that may be observed when the display apparatus displays two-dimensional images.

Additional features of the invention will be set forth in the description that follows, and in part will be apparent from the description, or may be learned by practice of the invention.

An exemplary embodiment of the present invention provides a display apparatus comprising: a light illuminating unit to generate light; a display panel configured to display an image; and a changing panel disposed between the light illuminating unit and the display panel, the changing panel configured to be turned off in a two-dimensional operation mode to provide the light to the display panel and configured to be turned on in a three-dimensional operation mode to change an optical path of the light emitted from the light illuminating unit toward the display panel, wherein the changing panel comprises: a first substrate comprising a common electrode; a second substrate comprising a plurality of electrodes facing the common electrode and spaced apart from each other; and a liquid crystal layer interposed between the first substrate and the second substrate, and a brightness difference between an electrode area in which the electrodes are disposed and a non-electrode area corresponding to an area between the electrodes is less than or equal to about 3% in the two-dimensional operation mode.

An exemplary embodiment of the present invention also provides a display apparatus comprising: a light illuminating unit to generate light; a display panel to display an image; and a changing panel disposed between the light illuminating unit and the display panel, the changing panel configured to be turned off in a two-dimensional operation mode to provide the light to the display panel and configured to be turned on in a three-dimensional operation mode to change an optical path of the light emitted from the light illuminating unit toward the display panel, wherein the changing panel comprises: a first substrate comprising a common electrode; a second substrate comprising a plurality of electrodes facing the common electrode and spaced apart from each other and a compensation layer disposed in a non-electrode area adjacent to an electrode area, in which the electrodes are disposed, to compensate for a brightness difference between the electrode area and the non-electrode area; and a liquid crystal layer interposed between the first substrate and the second substrate.

Another exemplary embodiment of the present invention provides a display apparatus comprising: a light illuminating unit to generate light; a display panel configured to display an image; and a changing panel disposed between the light illuminating unit and the display panel, the changing panel configured to be turned off in a two-dimensional operation mode to provide the light to the display panel and configured to be turned on in a three-dimensional operation mode to change an optical path of the light emitted from the light illuminating unit toward the display panel, wherein the changing panel comprises: a first substrate comprising a common electrode; a second substrate comprising a plurality of electrodes facing the common electrode and spaced apart from each other and comprising a first region corresponding to an area in which the electrodes are disposed and a second region corresponding to an area between the electrodes; and a liquid crystal layer interposed between the first substrate and the second substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view showing a three-dimensional image display apparatus according to an exemplary embodiment of the present invention.

FIG. 2 is a cross-sectional view showing a two-dimensional operation mode of the three-dimensional image display apparatus shown in FIG. 1.

FIG. 3 is a cross-sectional view showing odd-numbered frames of a three-dimensional operation mode of the three-dimensional image display apparatus shown in FIG. 1.

FIG. 4 is a view showing a process in which the three-dimensional image is recognized in the odd-numbered frames.

FIG. 5 is a cross-sectional view showing even-numbered frames of the three-dimensional operation mode of the three-dimensional image display apparatus shown in FIG. 1.

FIG. 6 is a view showing a process in which the three-dimensional image is recognized in the even-numbered frames.

FIG. 7A is a cross-sectional view showing an arrangement of liquid crystals when a distance between a first electrode and a second electrode is about 15 micrometers.

FIG. 7B is a cross-sectional view showing an arrangement of liquid crystals when a distance between a first electrode and a second electrode is about 5 micrometers.

FIG. 8A is a graph showing a brightness difference according to positions when a distance between a first electrode and a second electrode is about 15 micrometers.

FIG. 8B is a graph showing a brightness difference according to positions when a distance between a first electrode and a second electrode is about 5 micrometers.

FIG. 9 is a cross-sectional view showing a barrier panel according to another exemplary embodiment of the present invention.

FIG. 10 is a view showing a light transmittance in an electrode area and a non-electrode area.

FIG. 11 is a graph showing a light transmittance according to a refractive anisotropy of the liquid crystals.

FIG. 12 is a cross-sectional view showing a barrier panel according to another exemplary embodiment of the present invention.

FIG. 13A to FIG. 13E are cross-sectional views showing a method of manufacturing the barrier panel shown in FIG. 12.

FIG. 14 is a cross-sectional view showing a three-dimensional operation mode of a three-dimensional image display apparatus according to another exemplary embodiment.

FIG. 15 is a cross-sectional view showing a lenticular panel shown in FIG. 14.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

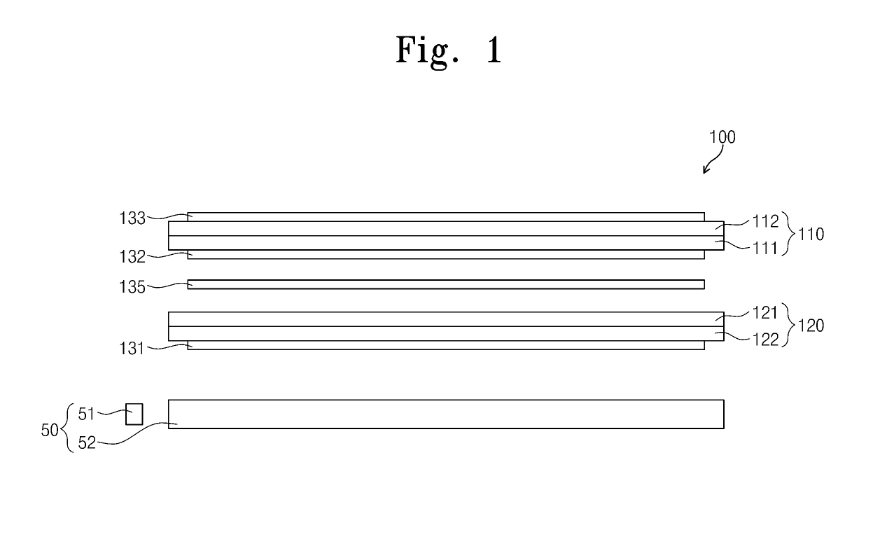

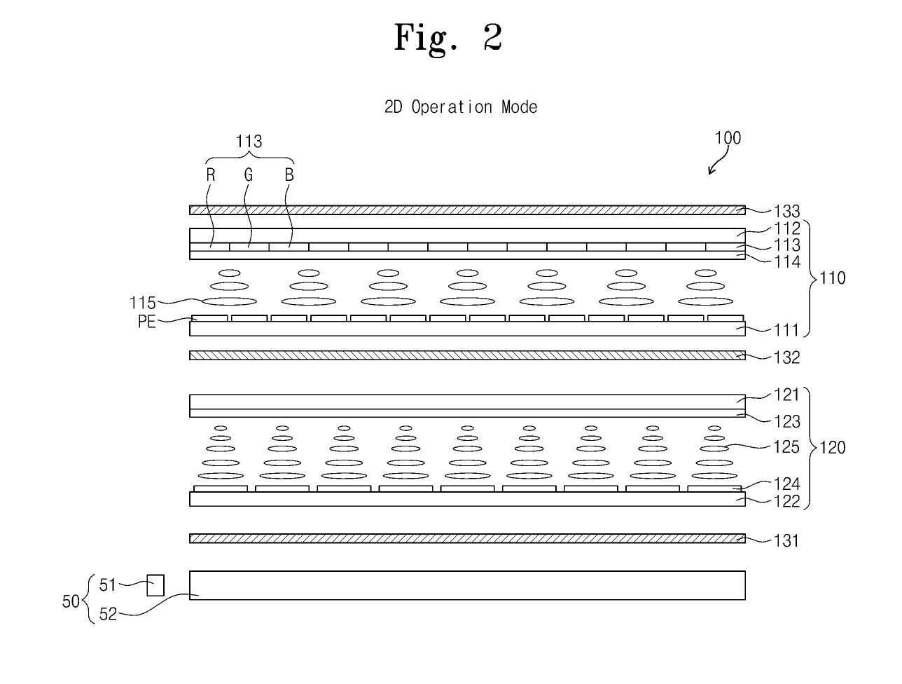

FIG. 1 is a cross-sectional view showing a three-dimensional image display apparatus according to an exemplary embodiment of the present invention, and FIG. 2 is a cross-sectional view showing a two-dimensional operation mode of the three-dimensional image display apparatus shown in FIG. 1.

Referring to FIG. 1 and FIG. 2, a three-dimensional (hereinafter, referred to as “3D”) image display apparatus 100 includes a backlight unit 50 for generating light, a liquid crystal display panel 110 for displaying an image, and a parallax barrier panel 120 interposed between the liquid crystal display panel 110 and the backlight unit 50.

The backlight unit 50 includes a light source 51 for emitting light and a light guide plate 52 for guiding the light to the parallax barrier panel 120. As an example, the light source 51 may include at least one light emitting diode and may be disposed adjacent to at least one side surface of the light guide plate 52.

The liquid crystal display panel 110 includes a first base substrate 111, a second base substrate 112 facing the first base substrate 111, and a first liquid crystal layer 115 interposed between the first base substrate 111 and the second base substrate 112. The first base substrate 111 includes a plurality of pixel electrodes PE arranged thereon in a matrix form. Although not shown in FIG. 1 and FIG. 2, the first base substrate 111 further includes gate lines extending in the row direction, data lines extending in the column direction, and thin film transistors connected to the pixel electrodes PE in one-to-one correspondence.

The second base substrate 112 includes a color filter layer 113 and a first common electrode 114. The color filter layer 113 includes red, green, and blue color pixels R, G, and B, and each of the color pixels R, G, and B is disposed to each pixel electrode of the pixel electrodes PE. The first common electrode 114 is disposed on the color filter layer 113 to form a vertical electric field with the pixel electrodes PE.

The first liquid crystal layer 115 includes a plurality of liquid crystal molecules aligned in the direction determined by the vertical electric field. Accordingly, the liquid crystal display panel 110 may control a transmittance of the light provided thereto in the pixel unit to display an image.

On the other hand, the parallax barrier panel 120 includes a first substrate 121, a second substrate 122 facing the first substrate 121, and a second liquid crystal layer 125 interposed between the first substrate 121 and the second substrate 122. The first substrate 121 includes a second common electrode 123 arranged thereon and the second substrate 122 includes a plurality of electrodes 124 arranged thereon. The second common electrode 123 may be a single-body electrode formed over a surface of the first substrate 121. Each of the electrodes 124 has a stripe shape extending in a predetermined direction. The electrodes 124 are substantially parallel to each other and spaced apart from each other at regular intervals.

The liquid crystal layer 125 may include twisted nematic liquid crystals, and the liquid crystals may be normally-white liquid crystals. In this case, the parallax barrier panel 120 is turned off in the two-dimensional (hereinafter, referred to as “2D”) operation mode in which 2D images are displayed, and thus the parallax barrier panel 120 transmits the light provided from the backlight unit 50 to output the light for the 2D image.

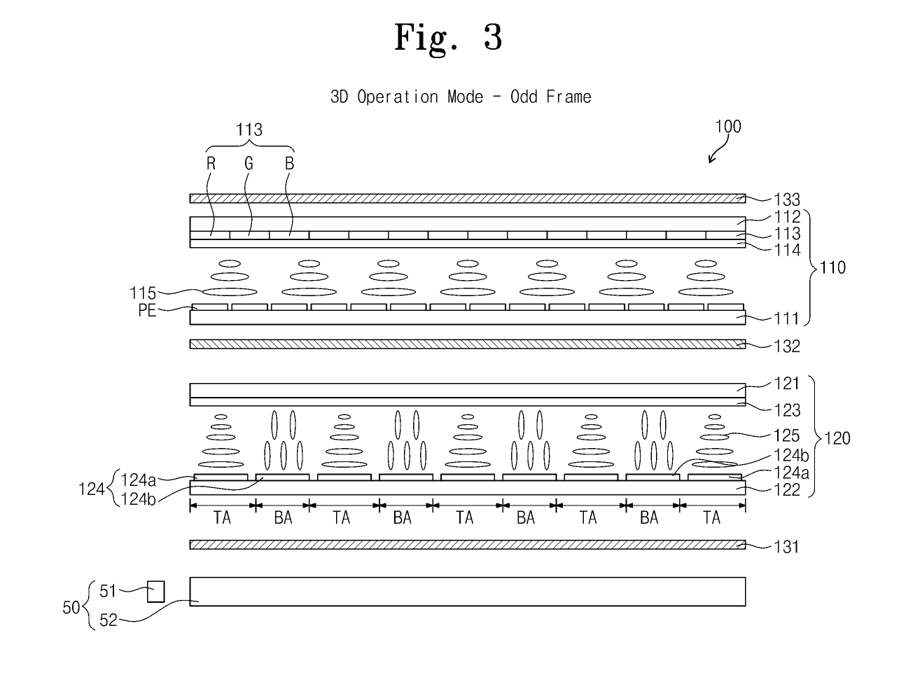

On the other hand, the parallax barrier panel 120 is turned on in the 3D operation mode in which the 3D image is displayed. The 3D operation mode will be described in detail with reference with FIG. 3 to FIG. 6.

In accordance with one exemplary embodiment, the parallax barrier panel 120 is disposed between the backlight unit 50 and the liquid crystal display panel 110. In this instance, even if the light emitted from the backlight unit 50 is diffracted going through the parallax barrier panel 120, the diffraction can be reduced as the light goes through the liquid crystal display panel, which typically includes several layers to disperse the paths of the light, for example, color filters and electrodes. Therefore, moiré phenomenon can be mitigated, which will contribute to a better display quality.

The 3D image display apparatus 100 further includes a first polarizing plate 131 disposed between the parallax barrier panel 120 and the backlight unit 50, a second polarizing plate 132 disposed between the parallax barrier panel 120 and the liquid crystal display panel 110, and a third polarizing plate 133 disposed on the liquid crystal display panel 110. The first polarizing plate 131 has a first absorbing axis substantially parallel to one of two diagonal lines of the liquid crystal display panel 110. The second liquid crystal layer 125 disposed on the parallax barrier panel 120 includes twisted nematic liquid crystals, and thus the second polarizing plate 132 has a second absorbing axis substantially perpendicular to the first absorbing axis. In addition, since the first liquid crystal layer 114 disposed on the liquid crystal display panel 110 includes the twisted nematic liquid crystals, the third polarizing plate 133 has a third absorbing axis substantially perpendicular to the second absorbing axis.

In the present exemplary embodiment, the second and third polarizing plates 132 and 133 may be attached to a lower surface and an upper surface of the liquid crystal display panel 110, respectively, and the first polarizing plate 131 may be attached to a lower surface of the parallax barrier panel 120.

The 3D image display apparatus 100 further includes an adhesive film 135 disposed between the second polarizing plate 132 and the parallax barrier panel 120 to attach the parallax barrier panel 120 to the liquid crystal display panel 110.

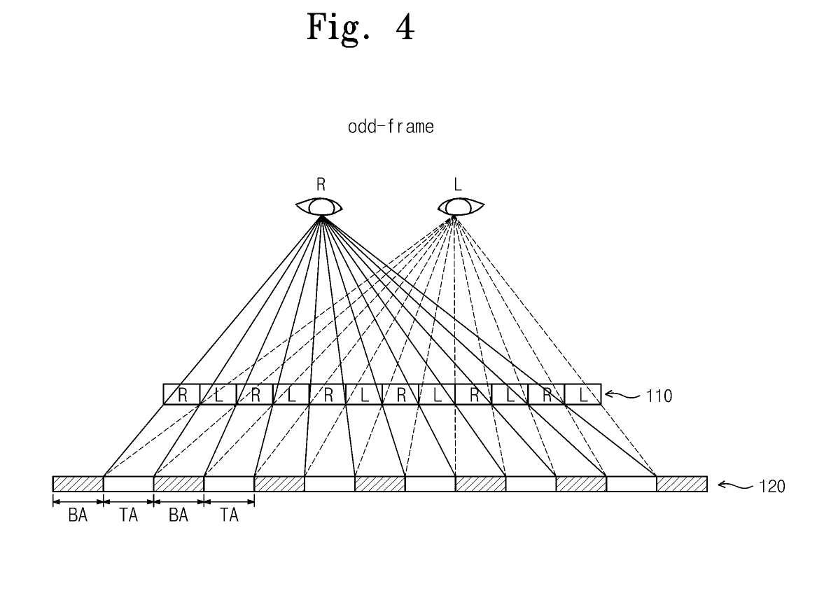

FIG. 3 is a cross-sectional view showing odd-numbered frames of a 3D operation mode of the 3D image display apparatus shown in FIG. 1, and FIG. 4 is a view showing a process in which the 3D image is recognized in the odd-numbered frames.

Referring to FIG. 3 and FIG. 4, the 3D image display apparatus 100 may be differently operated in accordance with the odd- and even-numbered frames during the 3D operation mode. In this case, the electrodes 124 disposed on the parallax barrier panel 120 are divided into first electrodes 124a used to form light transmission areas TA in the odd-numbered frames and second electrodes 124b used to form light blocking areas BA in the odd-numbered frames. The first electrodes 124a are alternately arranged with the second electrodes 124b.

The first electrodes 124a forming the light transmission areas TA in the odd-numbered frames are maintained in a turn-off state because the first electrodes 124a do not receive a driving voltage from an external device (not shown). Because the second liquid crystal layer 125 includes the normally-white liquid crystals, the light provided from the backlight unit 50 passes through the liquid crystals in the light transmission areas TA to reach the liquid crystal display panel 110.

On the other hand, the second electrodes 124b forming the light blocking areas BA in the odd-numbered frames are turned on in response to the driving voltage from the external device. When the second electrodes 124b are turned on, the vertical electric field is generated between the second common electrode 123 and the second electrodes 124b, thereby aligning the liquid crystals in the light blocking areas BA. Thus, the light provided from the backlight unit 50 is blocked by the second liquid crystal layer 125 in the light blocking areas BA.

In the 3D operation mode, the areas between the first electrodes 124a and the second electrodes 124b, which are adjacent to each other, may be included in the light transmission areas TA.

The liquid crystal display panel 110 is divided into a left-eye pixel part L to display images for the left eye and a right-eye pixel part R to display images for the right eye in the 3D operation mode. The left-eye pixel part L and the right-eye pixel part R are alternately arranged with each other. Accordingly, the light passing through the light transmission areas TA of the parallax barrier panel 120 is provided to the right and left eyes of a user through the right-eye pixel part R and the left-eye pixel part L, respectively. Thus, the user may perceive the images displayed on the liquid crystal display panel 110 as 3D images due to binocular disparity.

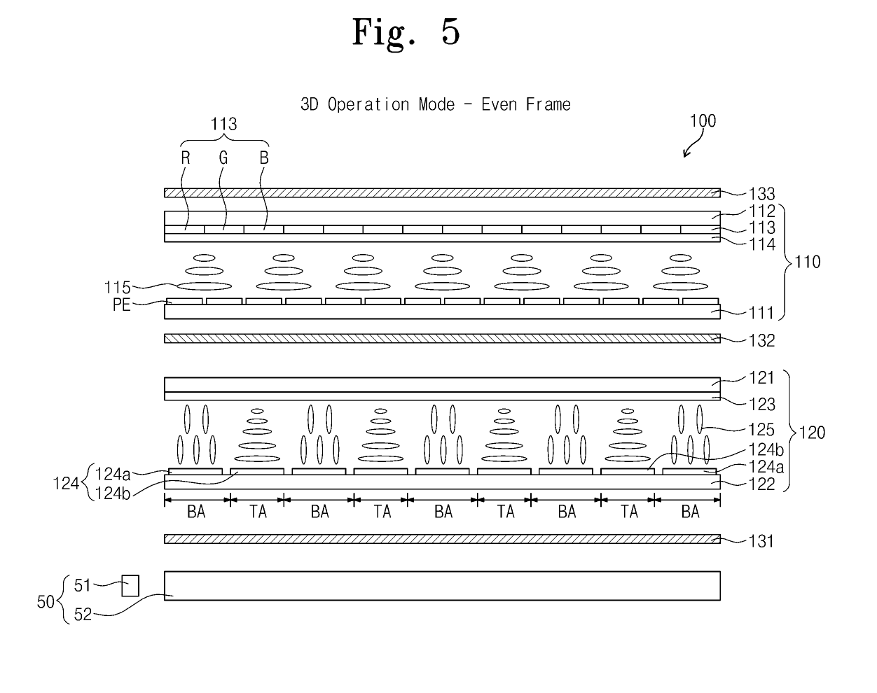

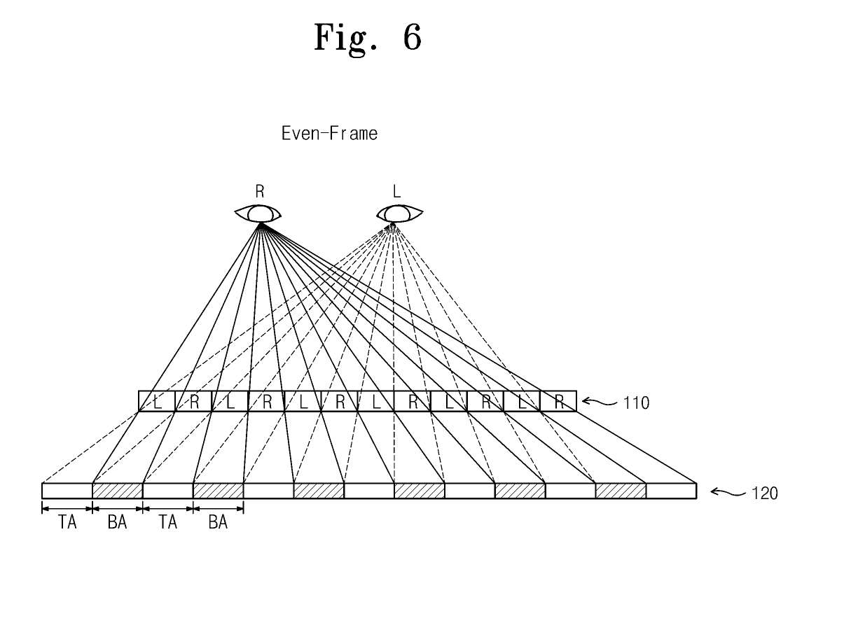

FIG. 5 is a cross-sectional view showing even-numbered frames of the 3D operation mode of the 3D image display apparatus shown in FIG. 1, and FIG. 6 is a view of a process in which the 3D image is recognized in the even-numbered frames.

Referring to FIG. 5 and FIG. 6, the first electrodes 124a form the light blocking areas BA in the even-numbered frames, and the second electrodes 124b form the light transmission areas TA in the even-numbered frames.

That is, the second electrodes 124b forming the light transmission areas TA in the even-numbered frames are maintained in a turn-off state because the second electrodes 124b do not receive the driving voltage from the external device. Because the second liquid crystal layer 125 includes normally-white liquid crystals, the light provided from the backlight unit 50 passes through the liquid crystals in the light transmission areas TA to reach the liquid crystal display panel 110.

On the other hand, the first electrodes 124a forming the light blocking areas BA in the even-numbered frames are turned on in response to the driving voltage from the external device. When the first electrodes 124a are turned on, a vertical electric field is generated between the second common electrode 123 and the first electrodes 124a, thereby aligning the liquid crystals in the light blocking areas BA in a different direction from the liquid crystals in the light transmission area TA. Thus, the light provided from the backlight unit 50 is blocked by the second liquid crystal layer 125 in the light blocking areas BA.

The light passing through the light transmission areas TA of the parallax barrier panel 120 is provided to the right and left eyes of the user through the right-eye pixel part R and the left-eye pixel part L, respectively. Thus, the user can perceive the images displayed on the liquid crystal display panel 110 as 3D images due to binocular disparity.

In the above-mentioned embodiment, the first and second electrodes 124a and 124b are alternately operated with each other in the unit of one frame. However, in the case that the one frame is divided into two sub-frames, the first and second electrodes 124a and 124b may be alternately operated with each other in the unit of one sub-frame.

In accordance with one exemplary embodiment, when the first and second electrodes 124a and 124b are alternately operated with each other in the unit of one frame or one sub-frame as described above, the distance between the first electrodes 124a and the second electrodes 124b, which are adjacent to each other, may be determined to be equal to or smaller than, for instance, about 5 micrometers.

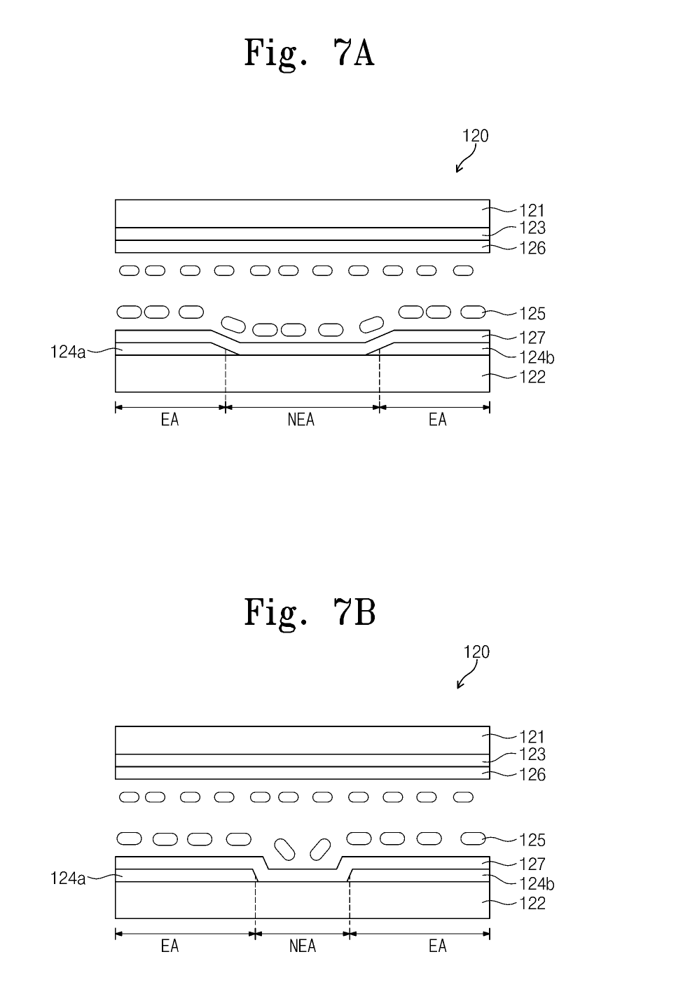

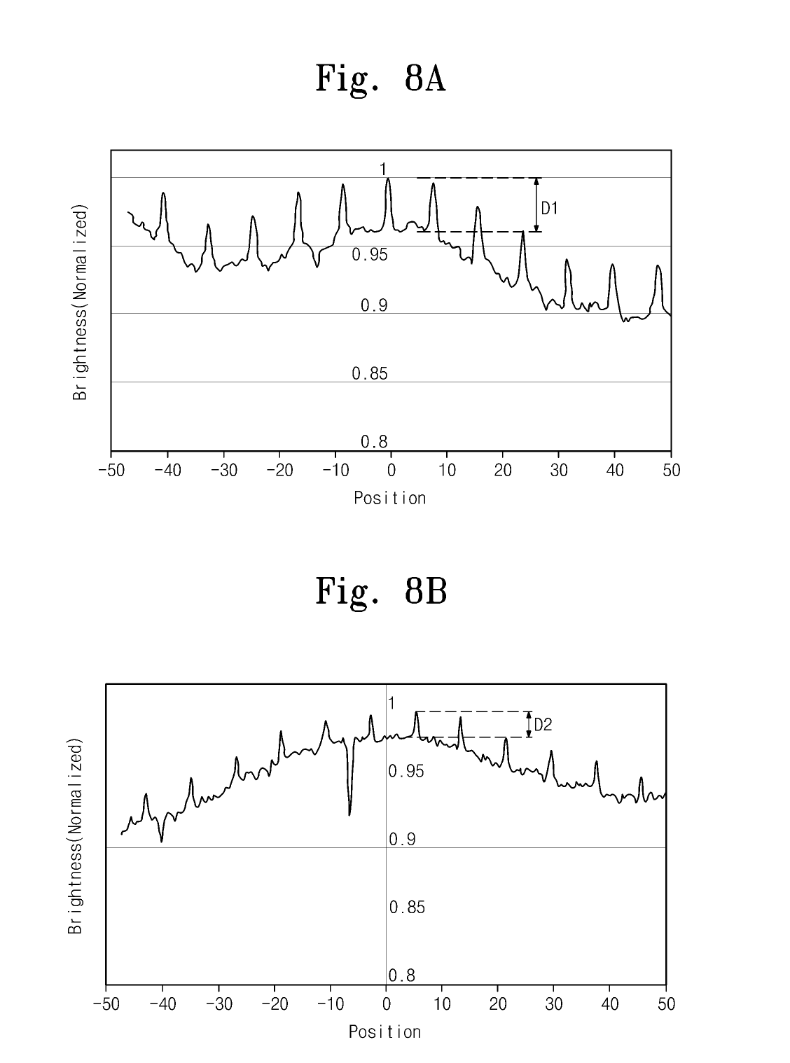

FIG. 7A is a cross-sectional view showing an arrangement of liquid crystals when the distance between the first electrode and the second electrode is about 15 micrometers, and FIG. 7B is a cross-sectional view showing an arrangement of liquid crystals when the distance between the first electrode and the second electrode is about 5 micrometers. In addition, FIG. 8A is a graph showing brightness differences according to positions when the distance between the first electrode and the second electrode is about 15 micrometers, and FIG. 8B is a graph showing brightness differences according to positions when the distance between the first electrode and the second electrode is about 5 micrometers.

Referring to FIG. 7A and FIG. 8A, the areas in which the first and second electrodes 124a and 124b are formed are referred to as an electrode area “EA”, and the areas disposed between the first and second electrodes 124a and 124b are referred to as a non-electrode area “NEA.”

The first and second electrodes 124a and 124b may include a transparent conductive material, such as indium tin oxide (ITO).

In the 2D operation mode, the parallax barrier panel 120 transmits light, but there may be brightness differences between the electrode area EA and the non-electrode area NEA due to the refractive index of the first and second electrodes 124a and 124b. That is, the light provided from the backlight unit 50 may be partially refracted or reflected by the first and second electrodes 124a and 124b, thereby losing some of the light. As a result, the brightness in the non-electrode area NEA appears relatively higher than the brightness in the electrode area EA.

Particularly, in the case that the distance between the first and second electrodes 124a and 124b, i.e., the width of the non-electrode area NEA, is about 15 micrometers, the liquid crystals are laid substantially parallel to the upper surface of the second substrate 122 in the non-electrode area NEA. Consequently, when the liquid crystals are laid substantially parallel to the second substrate 122, the light transmittance may be improved in the non-electrode area NEA.

As shown in FIG. 8A, when the width of the non-electrode area NEA is about 15 micrometers, the brightness difference D1 between the non-electrode area NEA and the electrode area EA is in a range of about 3.5% to about 4.5%. In other words, as the width of the non-electrode area NEA increases, the brightness difference between the electrode area EA and the non-electrode area NEA becomes larger.

Referring to FIG. 7B and FIG. 8B, in the case that the width of the non-electrode area NEA is about 5 micrometers, the liquid crystals in the non-electrode area NEA are inclined at non-zero degrees with respect to the upper surface of the second substrate 122. When the liquid crystals are inclined, the light transmittance is reduced compared to when the liquid crystals are substantially parallel to the upper surface of the second substrate 122. Thus, when the width of the non-electrode area NEA is reduced, the light transmittance of the non-electrode area NEA decreases accordingly, thereby reducing the brightness differences between the electrode area EA and the non-electrode area NEA.

As shown in FIG. 8B, when the width of the non-electrode area NEA is about 5 micrometers, the brightness difference D2 between the non-electrode area NEA and the electrode area EA is about 2%.

In the case that the brightness difference between the electrode area EA and the non-electrode area NEA is smaller than about 3%, the light for the 2D operation mode is provided to the liquid crystal display panel 110 after passing through the parallax barrier panel 120, and then is diffused by the color filter layer 113 in the liquid crystal display panel 110. Accordingly, when the brightness difference between the electrode area EA and the non-electrode area NEA of the parallax barrier panel 120 is smaller than about 3%, the moiré phenomenon is not perceived in the 2D operation mode. Thus, in one exemplary embodiment, the non-electrode area NEA may have the width equal to or smaller than 5 micrometers in order to reduce the brightness difference between the electrode area EA and the non-electrode area NEA to about 3% or less.

In addition, when the refractive index of the first and second electrodes 124a and 124b decreases, the loss of the light provided from the backlight unit 50 may be prevented, while it would otherwise be caused by the first and second electrodes 124a and 124b. Thus, according to one exemplary embodiment, the first and second electrodes 124a and 124b may be formed of a transparent material having a refractive index equal to or smaller than 2.0, for instance.

Referring again to FIG. 7A and FIG. 7B, a first alignment layer 126 disposed on the first common electrode 123 and a second alignment layer 127 covering the first and second electrodes 124a and 124b are shown.

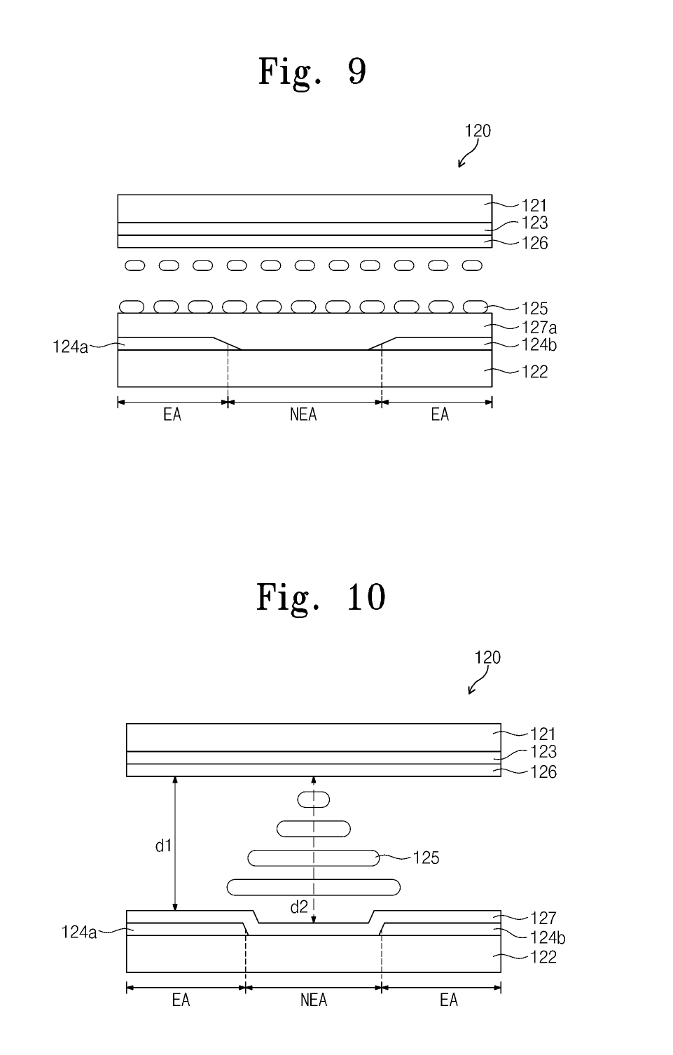

FIG. 9 is a cross-sectional view showing a barrier panel according to another exemplary embodiment of the present invention.

Referring to FIG. 9, a parallax barrier panel 120 according to another exemplary embodiment includes the first common electrode 123 disposed on the first substrate 121 and the first and second electrodes 124a and 124b disposed on the second substrate 122. The areas in which the first and second electrodes 124a and 124b are formed are referred to as an electrode area “EA”, and the areas disposed between the first and second electrodes 124a and 124b are referred to as a non-electrode area “NEA.”

The parallax barrier panel 120 further includes a first alignment layer 126 disposed on the first common electrode 123 and a second alignment layer 127a covering the first and second electrodes 124a and 124b. In particular, the second alignment layer 127a covers the electrode area EA and the non-electrode area NEA.

In the present exemplary embodiment, the second alignment layer 127a may have a thickness greater than that of the first alignment layer 126. The thicker second alignment layer 127a may reduce a step-difference between the electrode area EA and the non-electrode area NEA.

Accordingly, the brightness in the non-electrode area NEA may be reduced. In other words, the brightness in the non-electrode area NEA may be set to be equal to the brightness in the electrode area EA by adjusting the thickness of the second alignment layer 127a.

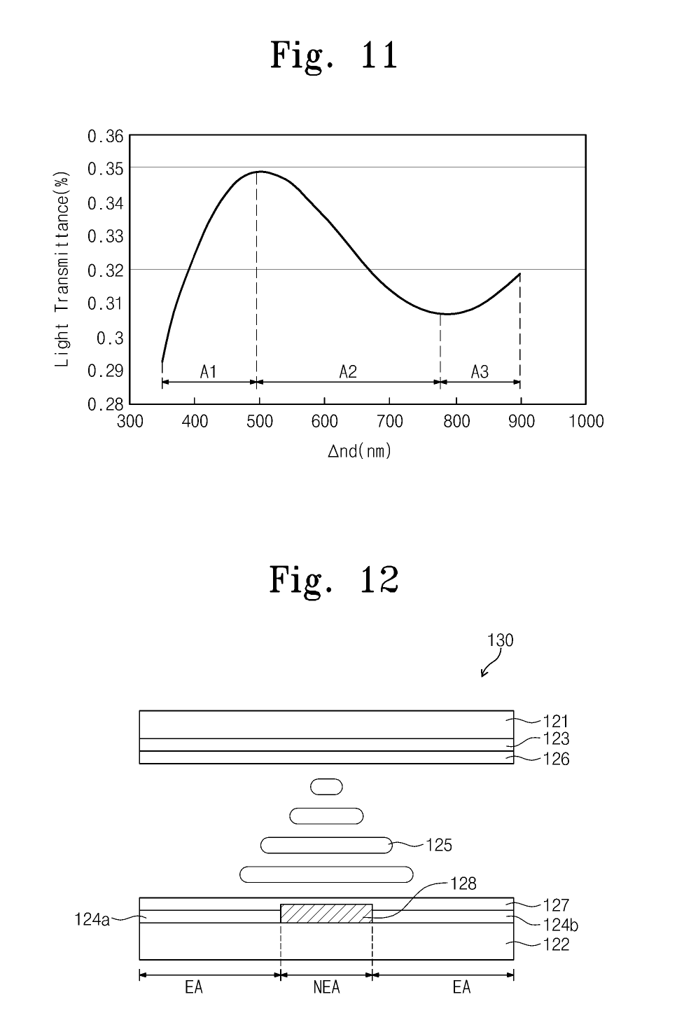

FIG. 10 is a view showing a mode of light transmittance in an electrode area and a non-electrode area, and FIG. 11 is a graph showing a light transmittance according to a phase difference (Δnd) of the liquid crystals.

Referring to FIG. 10 and FIG. 11, the second liquid crystal layer 125 of the parallax barrier panel 120 includes the liquid crystals having the phase difference Δnd (“Δn” denotes a refractive index anisotropy, and “d” denotes a cell gap) of about 480 nm to about 700 nm.

More specifically, FIG. 11 shows a first period A1 during which the phase difference Δnd of the liquid crystals is about 480 nm or less, a second period A2 during which the phase difference Δnd of the liquid crystals is in a range of about 480 nm to about 700 nm, and a third period A3 during which the phase difference Δnd of the liquid crystals is about 700 nm or more.

The light transmittance increases in the first and third periods A1 and A3 as the phase difference Δnd of the liquid crystals increases, but the light transmittance decreases in the second period A2 as the phase difference Δnd of the liquid crystals increases.

As shown in FIG. 10, a cell gap d1 in the electrode area EA is smaller than a cell gap d2 in the non-electrode area NEA. In detail, the cell gap d1 in the electrode area EA is smaller than the cell gap d2 in the non-electrode area NEA by the thickness of either of the first and second electrodes 124a and 124b. Accordingly, the phase difference Δnd of the liquid crystals in the non-electrode area NEA is greater than the phase difference Δnd of the liquid crystals in the electrode area EA. Because the light transmittance decreases in the second period A2 as the phase difference Δnd of the liquid crystals increases, the brightness difference between the electrode area EA and the non-electrode area NEA may be reduced when the liquid crystals having the phase difference in the second period A2 is applied to the parallax barrier panel 120.

In particular, the difference between the phase difference Δnd of the liquid crystals in the non-electrode area NEA and the phase difference Δnd of the liquid crystals in the electrode area EA may be set in a range of about 15 nm to about 30 nm so as to reduce the brightness difference between the electrode area EA and the non-electrode area NEA to about 2% or less.

FIG. 12 is a cross-sectional view showing a barrier panel according to another exemplary embodiment of the present invention.

Referring to FIG. 12, a parallax barrier panel 130 according to another exemplary embodiment further includes a compensation layer 128 disposed on the second substrate 122 corresponding to the non-electrode area NEA. The compensation layer 128 may have a refractive index substantially equal to the refractive index of the first and second electrodes 124a and 124b, while its thickness may vary depending on the refractive index thereof.

In an exemplary embodiment that the compensation layer 128 is not formed, when the brightness in the non-electrode area NEA is 100%, the brightness in the electrode area EA would be lower than the brightness in the non-electrode area NEA, e.g., about 97%, due to the first and second electrodes 124a and 124b. In contrast, in a different exemplary embodiment that the compensation layer 128 is formed in the non-electrode area NEA, refractions and reflections may be observed in the non-electrode area NEA due to the compensation layer 128. Accordingly, the brightness in the non-electrode area NEA may be reduced. In other words, the brightness in the non-electrode area NEA may be set to be equal to the brightness in the electrode area EA by adjusting the refractive index and the thickness of the compensation layer 128.

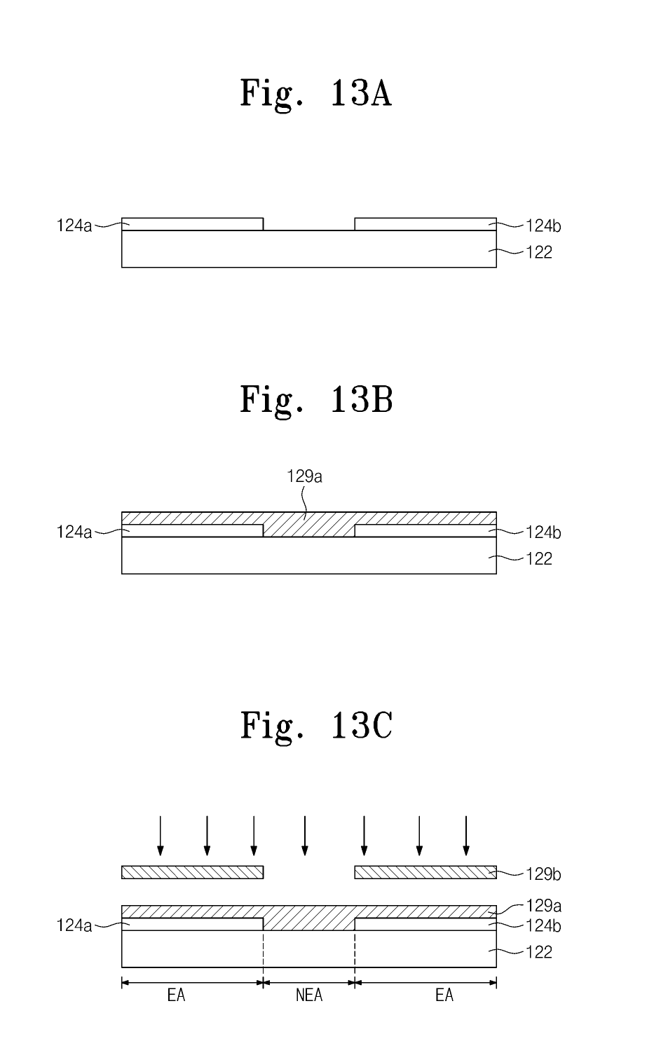

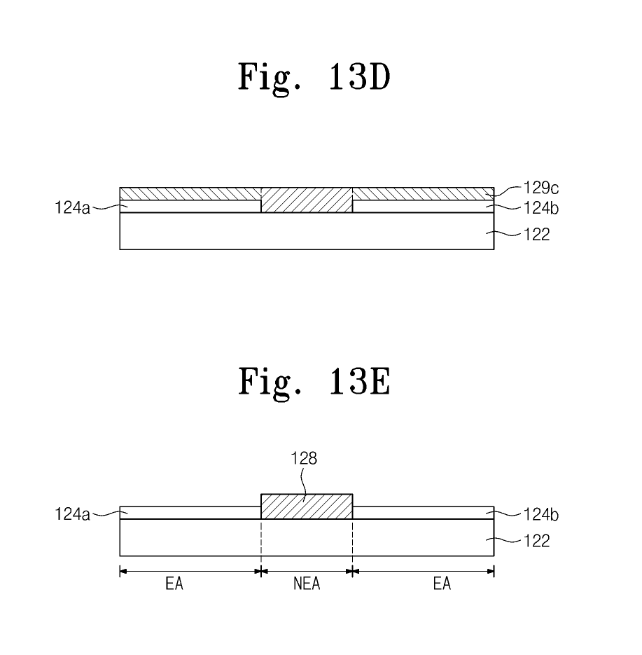

FIG. 13A to FIG. 13E are cross-sectional views showing a method of manufacturing the barrier panel shown in FIG. 12.

Referring to FIG. 13A, the first and second electrodes 124a and 124b spaced apart from each other are formed on the second substrate 122. Then, as shown in FIG. 13B, a photosensitive organic layer 129a is formed on the second substrate 122 to cover the first and second electrodes 124a and 124b. The photosensitive organic layer also covers the area between the first and second electrodes 124a and 124b, i.e., the non-electrode area NEA as shown in FIG. 11.

Referring to FIG. 13C, a mask 129b is disposed over the photosensitive organic layer 129a, and the photosensitive organic layer 129a is exposed to light. The mask 129b is provided with an opening formed therethrough to expose a portion of the photosensitive organic layer 129a disposed in the non-electrode area NEA. Accordingly, as shown in FIG. 13D, the portion of the photosensitive organic layer 129a that is exposed through the opening may be exposed to the light through an exposure process.

Then, when the portion of the photosensitive organic layer 129a that is not exposed is removed through development and etch processes, the compensation layer 128 may be formed in the non-electrode area NEA as shown in FIG. 13E.

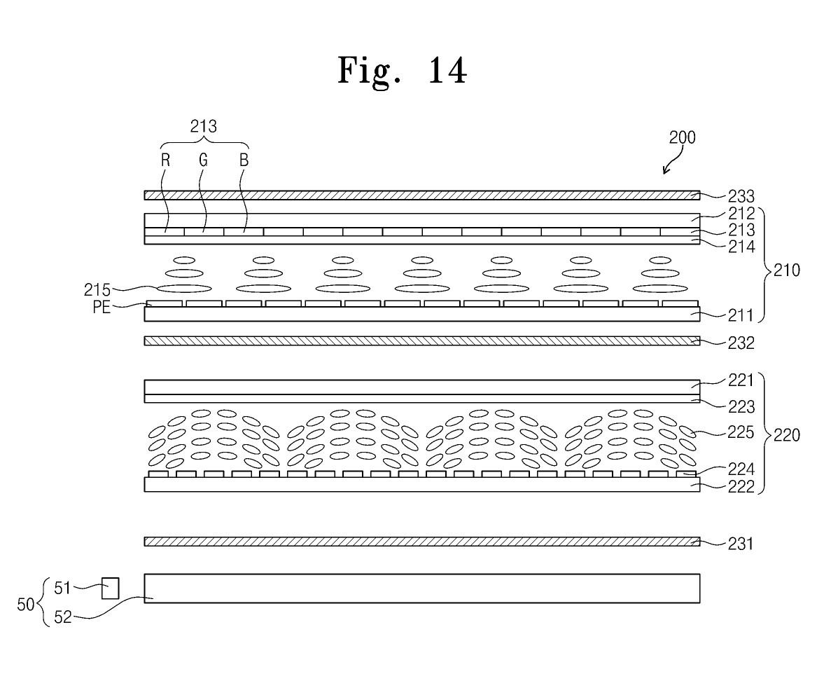

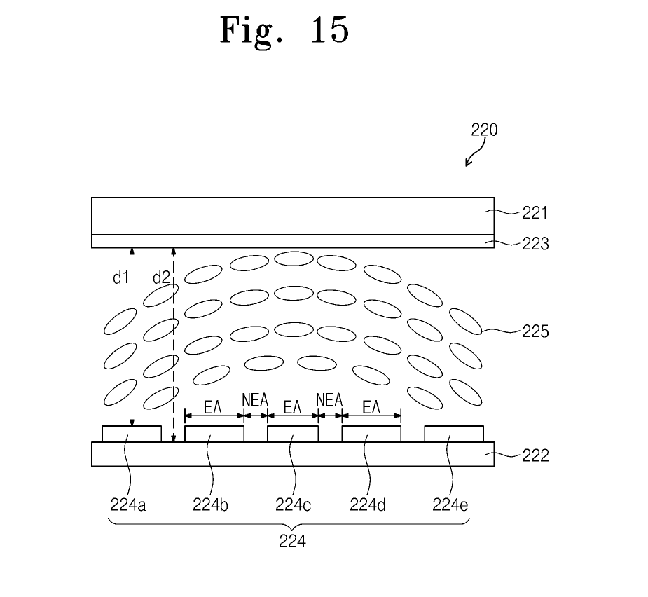

FIG. 14 is a cross-sectional view showing a three-dimensional operation mode of a three-dimensional image display apparatus according to yet another exemplary embodiment, and FIG. 15 is a cross-sectional view showing a lenticular panel as shown in FIG. 14.

Referring to FIG. 14 and FIG. 15, a 3D image display apparatus 200 according to yet another exemplary embodiment includes a backlight unit 50, a liquid crystal display panel 210, and a lenticular panel 220. The backlight unit 50 and the liquid crystal display panel 210 have the same structure and function as those of the backlight unit 50 and the liquid crystal display panel 110, and thus detailed descriptions of the backlight unit 50 and the liquid crystal display panel 210 are not repeated.

The lenticular panel 220 includes a first substrate 221, a second substrate 222 facing the first substrate 221, and a second liquid crystal layer 225 interposed between the first substrate 221 and the second substrate 222. A second common electrode 223 is disposed on the first substrate 221, and a plurality of electrodes 224 is disposed on the second substrate 222. The second common electrode 223 may be a single-body electrode formed over a surface of the first substrate 221. In one exemplary embodiment, each of the electrodes 224 may be formed in a stripe shape extending in a predetermined direction. Also, the electrodes 224 may be substantially parallel to each other and spaced apart from each other at regular intervals.

Further, the second liquid crystal layer 225 may include twisted nematic liquid crystals, and the liquid crystals may be normally-white liquid crystals. In this case, the lenticular panel 220 is turned off in the 2D operation mode for displaying 2D images only, and thus the lenticular panel 220 substantially entirely transmits the light provided from the backlight unit 50 to generate 2D images. Accordingly, the liquid crystal display panel 110 receives the light for 2D images from the lenticular panel 220 and displays the 2D images in the 2D operation mode. In this instance, the 2D operation mode of the lenticular panel 220 is substantially the same as the 2D operation mode of the parallax barrier panel 120 as shown in FIG. 2, and thus figures showing the 2D operation mode of the lenticular panel 220 are not repeatedly provided.

On the other hand, the lenticular panel 220 is turned on in the 3D operation mode for displaying 3D images. The liquid crystals included in the second liquid crystal layer 225 are arranged in a lenticular lens shape during the 3D operation mode. The liquid crystals forming one lenticular lens may be controlled by at least two sub-electrodes. As an example, each of the electrodes 224 includes first, second, third, fourth, and fifth sub-electrodes 224a, 224b, 224c, 224d, and 224e to which different driving voltages from one another may be applied. In order to form the lenticular lens having a stripe shape extending in one direction, the first, second, third, fourth, and fifth sub-electrodes 224a, 224b, 224c, 224d, and 224e may have a stripe shape extending in one direction.

The first to fifth sub-electrodes 224a, 224b, 224c, 224d, and 224e are spaced apart from each other by a predetermined distance so as to receive the different driving voltages from one another. As shown in FIG. 15, the areas in which the first to fifth sub-electrodes 224a, 224b, 224c, 224d, and 224e are formed are referred to as an electrode area EA, and the areas in which the first to fifth sub-electrodes 224a, 224b, 224c, 224d, and 224e are not formed are referred to as a non-electrode area NEA. The non-electrode area NEA corresponds to an area between two sub-electrodes adjacent to each other.

As an example, when the width of the non-electrode area NEA is about 5 micrometers or less, the brightness difference between the non-electrode area NEA and the electrode area EA may be reduced to about 3% or less.

In the case that the brightness difference between the electrode area EA and the non-electrode area NEA is smaller than about 3%, the light for the 2D operation mode is provided to the liquid crystal display panel 210 after passing through the lenticular panel 220 and then is diffused by the color filter layer 213 in the liquid crystal display panel 210. Accordingly, when the brightness difference between the electrode area EA and the non-electrode area NEA of the lenticular panel 220 is smaller than about 3% or less, the moiré phenomenon is not perceived in the 2D operation mode. Thus, in the present exemplary embodiment, the non-electrode area NEA may have a width equal to or smaller than 5 micrometers in order to reduce the brightness difference between the electrode area EA and the non-electrode area NEA to about 3% or less.

In addition, when the refractive index of the first to fifth sub-electrodes 224a, 224b, 224c, 224d, and 224e is reduced, the loss of the light provided from the backlight unit 50, which may be caused by the reflection of the first to fifth electrodes 224a, 224b, 224c, 224d, and 224e, may be prevented. Thus, the first to fifth electrodes 224a, 224b, 224c, 224d, and 224e may be formed of a transparent material having a refractive index equal to or smaller than 2.0.

In particular, when the first to fifth electrodes 224a, 224b, 224c, 224d, and 224e have a refractive index from about 1.5 to about 1.6, the brightness difference between the electrode area EA and the non-electrode area NEA may be reduced to about 2% or less.

Although not shown in FIG. 14 or FIG. 15, a compensation layer, which is similar to compensation layer 128 of FIG. 12, may be provided in the non-electrode areas NEA between the first to fifth electrodes 224a, 224b, 224c, 224d, and 224e. The compensation layer between the first to fifth electrodes 224a, 224b, 224c, 224d, and 224e may be formed using a similar process as described in FIGS. 13A-13E to form compensation layer 128.

While this invention has been described in connection with exemplary embodiments, it is to be understood that the invention is not limited to the exemplary embodiments. It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A display apparatus comprising:
a light illuminating unit to generate light;
a display panel configured to display an image; and
a changing panel disposed between the light illuminating unit and the display panel, the changing panel configured to be turned off in a two-dimensional operation mode to provide the light to the display panel and configured to be turned on in a three-dimensional operation mode to change an optical path of the light emitted from the light illuminating unit toward the display panel,
wherein the changing panel comprises:
a first substrate comprising a common electrode;
a second substrate comprising a plurality of electrodes facing the common electrode and spaced apart from each other; and
a liquid crystal layer interposed between the first substrate and the second substrate, and a brightness difference between an electrode area in which the electrodes are disposed and a non-electrode area corresponding to an area between the electrodes is less than or equal to about 3% in the two-dimensional operation mode.

2. The display apparatus of claim 1, wherein a width of the non-electrode area is less than or equal to 5 micrometers.

3. The display apparatus of claim 1, wherein the electrodes comprise a transparent material and have a refractive index that is less than or equal to 2.0.

4. The display apparatus of claim 3, wherein the refractive index is in a range of about 1.5 to about 1.6.

5. The display apparatus of claim 1, wherein the liquid crystal layer has a phase difference in a range of about 480 nm to about 700 nm.

6. The display apparatus of claim 5, wherein a difference between the phase difference in the non-electrode area and the phase difference in the electrode area is in a range of about 15 nm to about 30 nm.

7. The display apparatus of claim 1, wherein the changing panel is a parallax barrier panel comprising a light transmission area configured to transmit the light and a light blocking area configured to block the light during the three-dimensional operation mode.

8. The display apparatus of claim 7, wherein the electrodes comprise first electrodes configured to provide the light transmission area during a first sub-frame period of an image frame and second electrodes configured to provide the light blocking area during the first sub-frame period of the image frame, and the first electrodes are spaced apart from and alternately arranged with the second electrodes.

9. The display apparatus of claim 8, wherein the first electrodes are configured to provide the light blocking area during a second sub-frame period of the image frame, and the second electrodes are configured to provide the light transmission area during the second sub-frame period of the image frame.

10. The display apparatus of claim 9, wherein an area disposed between the first and second electrodes adjacent to each other is included in the light transmission area.

11. The display apparatus of claim 8, wherein a distance between the first and second electrodes adjacent to each other is less than or equal to 5 micrometers.

12. The display apparatus of claim 1, wherein the changing panel is a lenticular panel in which liquid crystals are arranged in plural lens shapes in the three-dimensional operation mode, and the changing panel is configured to provide the light having the changed optical path to the display panel.

13. The display apparatus of claim 12, wherein each of the electrodes comprises a plurality of sub-electrodes spaced apart from each other and configured to receive different voltages from each other, and a distance between two electrodes adjacent to each other is less than or equal to 5 micrometers.

14. The display apparatus of claim 13, wherein a refractive index of the sub-electrodes is less than or equal to 2.0.

15. The display apparatus of claim 14, wherein the refractive index is in a range of about 1.5 to about 1.6.

16. A display apparatus comprising:
a light illuminating unit to generate light;
a display panel to display an image; and
a changing panel disposed between the light illuminating unit and the display panel, the changing panel configured to be turned off in a two-dimensional operation mode to provide the light to the display panel and configured to be turned on in a three-dimensional operation mode to change an optical path of the light emitted from the light illuminating unit toward the display panel,
wherein the changing panel comprises:
a first substrate comprising a common electrode;
a second substrate comprising a plurality of electrodes facing the common electrode and spaced apart from each other and a compensation layer disposed in a non-electrode area adjacent to an electrode area, in which the electrodes are disposed, to compensate for a brightness difference between the electrode area and the non-electrode area; and
a liquid crystal layer interposed between the first substrate and the second substrate.

17. The display apparatus of claim 16, wherein the electrodes comprise a transparent material, and the compensation layer is an organic insulating layer.

18. The display apparatus of claim 16, wherein the liquid crystal layer has a phase difference in a range of about 480 nm to about 700 nm.

19. The display apparatus of claim 16, wherein the changing panel is a parallax barrier panel comprising a light transmission area to transmit the light and a light blocking area to block the light during the three-dimensional operation mode.

20. A display apparatus comprising:
a light illuminating unit to generate light;
a display panel configured to display an image; and
a changing panel disposed between the light illuminating unit and the display panel, the changing panel configured to be turned off in a two-dimensional operation mode to provide the light to the display panel and configured to be turned on in a three-dimensional operation mode to change an optical path of the light emitted from the light illuminating unit toward the display panel,
wherein the changing panel comprises:
a first substrate comprising a common electrode;
a second substrate comprising a plurality of electrodes facing the common electrode and spaced apart from each other and comprising a first region corresponding to an area in which the electrodes are disposed and a second region corresponding to an area between the electrodes; and
a liquid crystal layer interposed between the first substrate and the second substrate.
